(19) United States
(12) Patent Application Publication
(10) Pub. No.: US 2015/0029734 A1
(43) Pub. Date: Jan. 29, 2015

(54) HEAT-DISSIPATING LAMP CAP OF A LIGHT-EMITTING DIODE TUBE

(71) Applicant: JITBOUNDARY UNITED PRODUCTION INC., NEW TAIPEI CITY (TW)

(72) Inventors: Po-Wen KO, New Taipei City (TW); Chin-Chia CHANG, New Taipei City (TW)

(21) Appl. No.: 14/328,883

(22) Filed: Jul. 11, 2014

(30) Foreign Application Priority Data
Jul. 26, 2013 (TW) 102126863

(51) Int. Cl. F21V 29/00; F21V 23/00; F21V 23/06

(52) U.S. Cl. CPC F21V 29/004; F21V 23/06; F21V 23/002
USPC 362/373

(57) ABSTRACT

A heat-dissipating lamp cap of a light-emitting diode (LED) tube has a tubular portion and a cap portion. The tubular portion has an annular wall and two openings. The annular wall has a heat-dissipating portion defined as a portion of the annular wall extending axially between the two openings and aligning with electronic elements over one end of the LED tube. The cap portion covers one of the openings of the tubular portion and has two electrodes and a conducting resilient piece. The conducting resilient piece has an electrode connection portion electrically connected to the electrodes and an abutting portion electrically connected to the LED tube. When the LED tube is operated, heat generated by the heating elements on ends of the LED tube can be dissipated through the heat-dissipating portion of the heat-dissipating lamp cap.

### BACKGROUND OF THE INVENTION

1. Field of the Invention

The present invention relates to a lamp cap of a light-emitting diode (LED) tube, and more particularly to an easily mountable heat-dissipating lamp cap.

2. Description of the Related Art

In view of light-emitting diode (LED) featured by compact size, better lighting efficiency and durable life cycle, LED tubes using LEDs as lighting sources gradually become the mainstream of the lighting market.

With reference to FIG. 5, a conventional LED tube has a heat sink 70, an LED light board 80, a tube cover 90 and two lamp caps 110. The heat sink 70 is semi-cylindrical and has multiple fins 71, a central recess, and two sliding slots 72. The fins 71 are formed by parallelly cutting into a cylindrical surface of the heat sink 70. The central recess is formed in a flat surface of the heat sink 70 and axially extends across the heat sink 70. The two sliding slots 72 are respectively formed in two opposite sidewalls of the central recess and axially extend across the heat sink 70. The LED light board 80 is slidably mounted into the heat sink 70 through the two sliding slots with two ends of the LED light board 80 being flush with two ends of the heat sink 70, and has multiple LED elements 82 and four power connection portions 81. The LED elements 82 are mounted on the LED light board 80. Each two power connection portions 81 are formed on two positions on the LED light board beside the respective sliding slots 72. The tube cover 90 is transparent and takes the form of a semi-round tube with a flat side partially opened. The tube cover 90 is mounted on the heat sink 70 with the partially opened side of the tube cover 90 corresponding to the sidewalls of the central recess of the heat sink 70 to constitute a tubular structure and cover the LED light board 80. Each lamp cap 110 is mounted around one end of the tubular structure formed by the heat sink 70 and the tube cover 90 and has two electrode terminals 111 respectively and electrically connected to the corresponding two power connection portions 81 of the LED light board 80 to supply power to the LED light board 80.

When the LED tube is inserted into two lamp holders and is turned on, the LED light board 80 acquires power through the electrode terminals 111 of the lamp caps 110 and the LED elements 80 start emitting light. Heat generated upon operation of the LED light board 80 is dissipated to the fins 71 of the heat sink 70 to increase the heat-dissipating area and heat-dissipating effect.

With reference to FIG. 6, the drawback of the conventional LED tube resides in that the two electrode terminals 111 of each lamp cap 110 are inserted into a lamp holder. For easy access to power, the power connection portions 81 of the LED light board 80 are arranged on both ends of the LED light board 80 adjacent to the respective electrode terminals 111. Electric wires 112 are soldered to electrically connect the respective electrode terminals 111 and power connection portions 81.

For the concern of insulation protection, after the electrical wires 112 are soldered, soldered points of the power connection portions 81 and the electric wires are insulated by applying insulating material 113 thereon as shown in FIG. 7 or by wrapping the soldered points with a soft mica sheet 114.

As there are a bunch of electronic elements, such as the power connection portions 81, on both ends of the LED light board 80 for processing power input, considerable heat is generated by the electronic elements during operation. However, the lamp caps 110 without heat-dissipating capability mounted on the two ends of the LED tube where the electronic elements are located lead to difficulty of heat dissipation. Additionally, the insulating material 113 and the soft mica sheet 114 that are not good at heat dissipation further worsen the heat-dissipating efficiency. Temperature rise on both sides of the LED tube may affect or even damage the efficacy of the LED tube.

### SUMMARY OF THE INVENTION

An objective of the present invention is to provide a heat-dissipating lamp cap of a light-emitting diode (LED) tube being efficient in heat dissipation and easily mountable.

To achieve the foregoing objective, the heat-dissipating lamp cap has a tubular portion and a cap portion.

The tubular portion has two openings and an annular wall.

The two openings are formed through two ends of the tubular portion and are opposite to each other.

The annular wall has a heat-dissipating portion defined as a portion of the annular wall extending axially between the two openings.

The cap portion covers one of the two openings of the tubular portion and has an insulating board, two electrodes and a conducting resilient piece.

The insulating board is securely mounted on an inner edge portion of one of the openings of the tubular portion.

The two electrodes are mounted through the insulating board.

The conducting resilient piece is mounted on an inner surface of the insulating board and has an electrode connection portion and an abutting portion.

The electrode connection portion is formed on the conducting resilient piece and extends radially to electrically connect to the two electrodes.

The abutting portion is formed on and protrudes in a direction toward the heat-dissipating portion of the annular wall, and is spaced apart from the heat-dissipating portion by a gap.

When the heat-dissipating lamp cap is mounted on one end of an LED tube, heat generated from the end of the LED tube can be dissipated through the heat-dissipating portion of the heat-dissipating lamp cap without causing high temperature rise arising from heat accumulated in the end of the LED tube.

Other objectives, advantages and novel features of the invention will become more apparent from the following detailed description when taken in conjunction with the accompanying drawings.

### BRIEF DESCRIPTION OF THE DRAWINGS

FIG. 1 is a partially exploded perspective view of a heat-dissipating lamp cap in accordance with the present invention coupled to an LED tube;

FIG. 2 is an enlarged perspective view of the heat-dissipating lamp cap in FIG. 1;

FIG. 3 is an enlarged side view in partial section of the heat-dissipating lamp cap in FIG. 1 coupled to an LED tube;

FIG. 4 is a perspective view of the heat-dissipating lamp cap assembled with an LED tube;

FIG. 5 is a partially exploded perspective view of a conventional lamp cap coupled to an LED tube;

FIG. 6 is a top view in partial section of the conventional lamp cover coupled to an LED tube;

FIG. 7 is a side view in partial section of a conventional LED tube with electric wires and power connection portions soldered by an insulating material; and

FIG. 8 is a side view in partial section of a conventional LED tube with electric wires and power connection portions wrapped by a soft mica sheet.

### DETAILED DESCRIPTION OF THE INVENTION

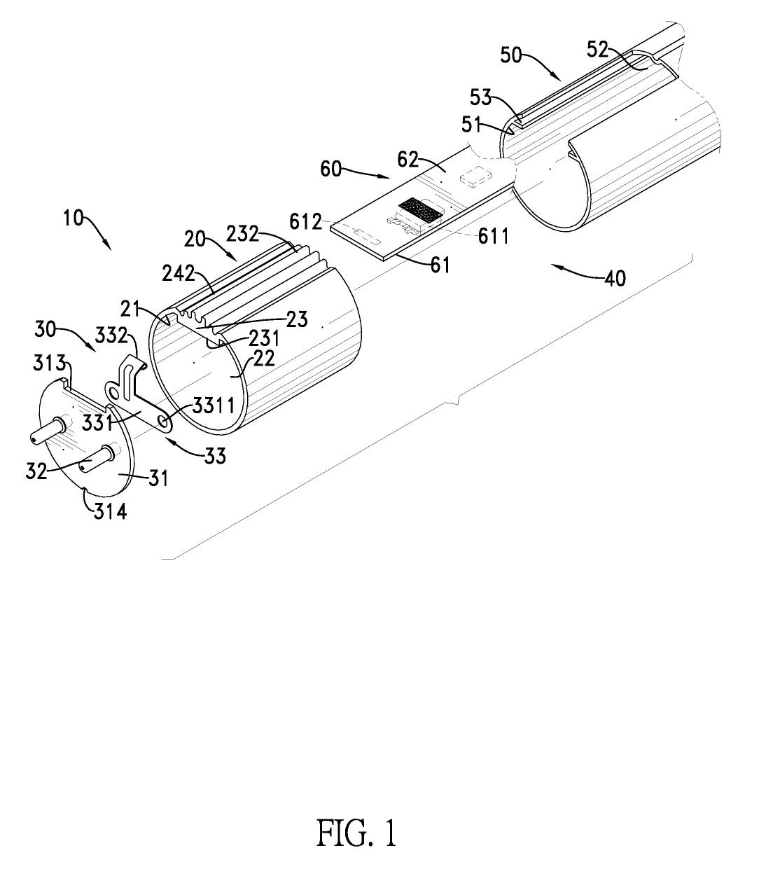

With reference to FIG. 1, a heat-dissipating lamp cap 10 of a light-emitting diode (LED) tube in accordance with the present invention has a tubular portion 20 and a cap portion 30.

The tubular portion 20 has two openings 21 and an annular wall 22 and may be made of a metal material. The openings 21 are formed through two ends of the tubular portion 20 and are opposite to each other. The annular wall 22 defines an inner space communicating with the two openings 21 and has a heat-dissipating portion 23. The heat-dissipating portion 23 is defined as a portion of the annular wall 22 extending axially between the two openings 21 with two ends of the heat-dissipating portion 23 being respectively flush with the openings 21. The heat-dissipating portion 23 has a flat surface 231 and multiple fins 232. The flat surface 231 is formed on an inner side of the heat-dissipating portion 23. The fins 232 are formed on and protrude outwards from an outer side of the heat-dissipating portion 23.

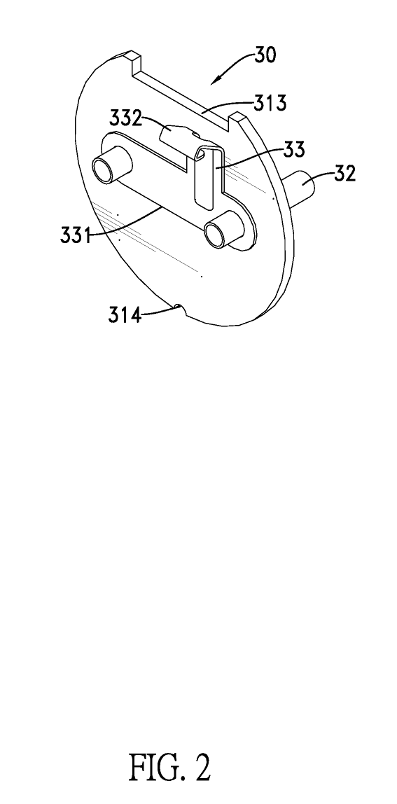

With reference to FIGS. 1 and 2, the cap portion 30 covers a corresponding opening 21 of the tubular portion 20 and has an insulating board 31, two electrodes 32 and a conducting resilient piece 33. The insulating board 31 corresponds to the openings 21 of the annular wall 20 in shape, is securely mounted on an inner edge portion of the corresponding opening 21, and has an indentation 313 and an adhesive-filling hole 314. The indentation 313 is formed on and recessed inwards from a perimeter of the insulating board 31 to correspond to the heat-dissipating portion 23 for the insulating board 31 to be securely mounted on the inner edge portion of the corresponding opening 21. The adhesive-filling hole 314 is formed on and recessed inwards from the perimeter of the insulating board 31 for filling adhesive material through the adhesive-filling hole 314. The filled adhesive material can flow to a portion between the insulating board 31 and the opening 21 of the tubular portion 20 by means of capillary effect to strength a bonding force between the insulating board 31 and the tubular portion 20 at the corresponding opening 21 of the tubular portion 20.

The two electrodes 32 are mounted through the insulating board 31. The conducting resilient piece 33 is mounted on an inner surface of the insulating board 31 and has an electrode connection portion 331 and an abutting portion 332. The electrode connection portion 331 is formed on the conducting resilient piece 33 and extends radially. The electrode connection portion 331 has two conducting holes 3311 formed therethrough such that the two electrodes 32 of the insulating board 31 can be respectively mounted through the conducting holes 3311 to electrically connect to the conducting resilient piece 33. The abutting portion 332 is formed on and protrudes in a direction toward the heat-dissipating portion 23 of the annular wall 22, and is spaced apart from the heat-dissipating portion 23 by a gap. A free end of the abutting portion 332 is bent toward the opening 21 of the tubular portion 20 that is distal to the free end.

With reference to FIG. 1, an LED tube 40 coupled to the foregoing heat-dissipating lamp cap 10 has a tube cover 50 and an LED light board 60.

The tube cover 50 is tubular and transparent and has two openings 51, a heat-dissipating notch 52 and two sliding rails 53. The two openings 51 are formed through two ends of the tube cover 50 and are opposite to each other. The heat-dissipating notch 52 is formed through an end portion of a periphery of the tube cover 50 and communicates with one of the openings 51 of the tube cover 50. The two sliding rails 53 are formed on an inner wall of the tube cover 50 and are parallel to the heat-dissipating notch 52.

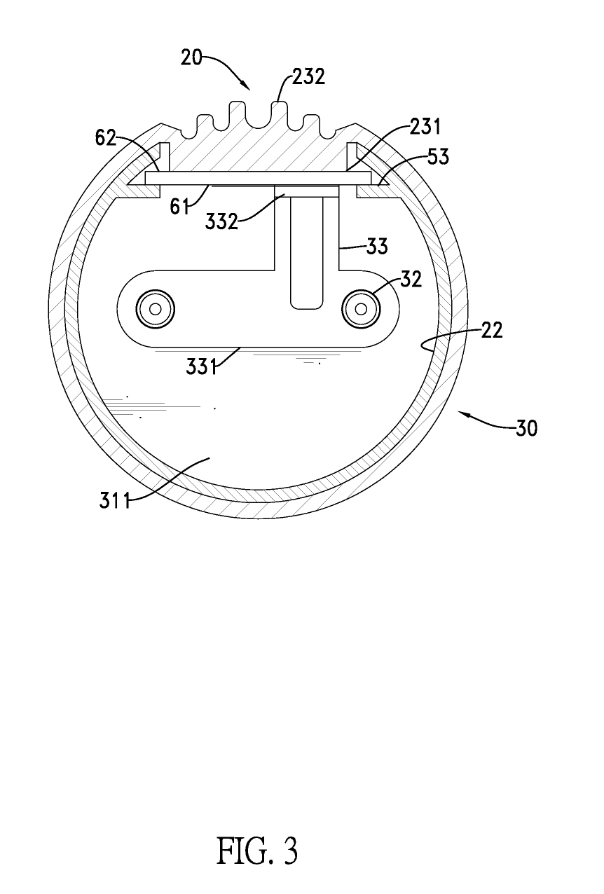

With reference to FIGS. 1 and 3, the LED light board 60 is slidably mounted on the two sliding rails 53 with each of two side edges of the LED light board 60 in a lengthwise direction of the LED light board 60 held between one of the sliding rails 53 and the inner wall of the tube cover 50. The LED light board 60 has a light-emitting surface 61, a backlight surface 62, a heating element 611 and a power connection portion 612. The backlight surface 62 is opposite to the light-emitting surface 61. The heating element 611 and the power connection portion 612 are formed on the light-emitting surface 61. The power connection portion 612 serves to contact the abutting portion 332 of the heat-dissipating lamp cap 10 and is electrically connected therewith to acquire an operating power required for operation of the LED light board 60. The power connection portion 612 may be a power board or a metal plate electrically connected to a hidden circuit of the LED light board 60. The backlight surface 62 of the LED light board 60 is closely attached to the flat surface 231 of the heat-dissipating portion 23. In other words, the LED light board 60 is located between the heating element 611 and the flat surface 231. The heating element 611 may be a processor, a transistor, a resistor, a capacitor or an LED.

When the LED tube 40 is operated, heat generated from the heating element 611 is transferred from the LED light board 60 to the fins 232 of the heat-dissipating portion 23 through the flat surface 231 for quick heat dissipation. Accordingly, the high-temperature issue caused by heat accumulated in both ends of a conventional LED tube can thus be resolved.

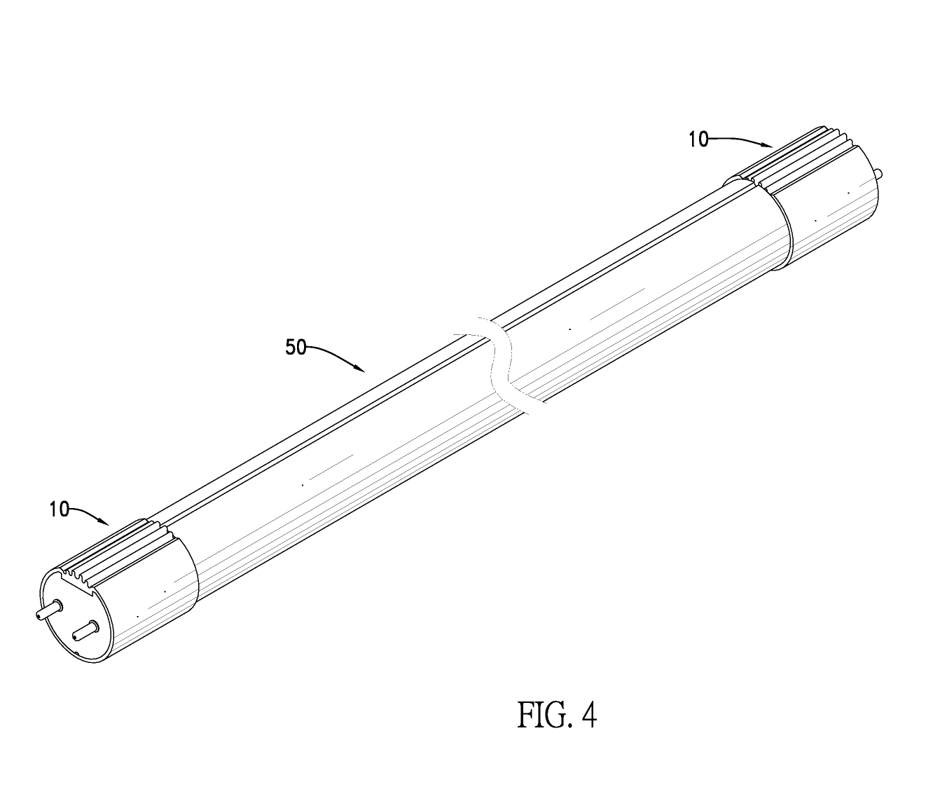

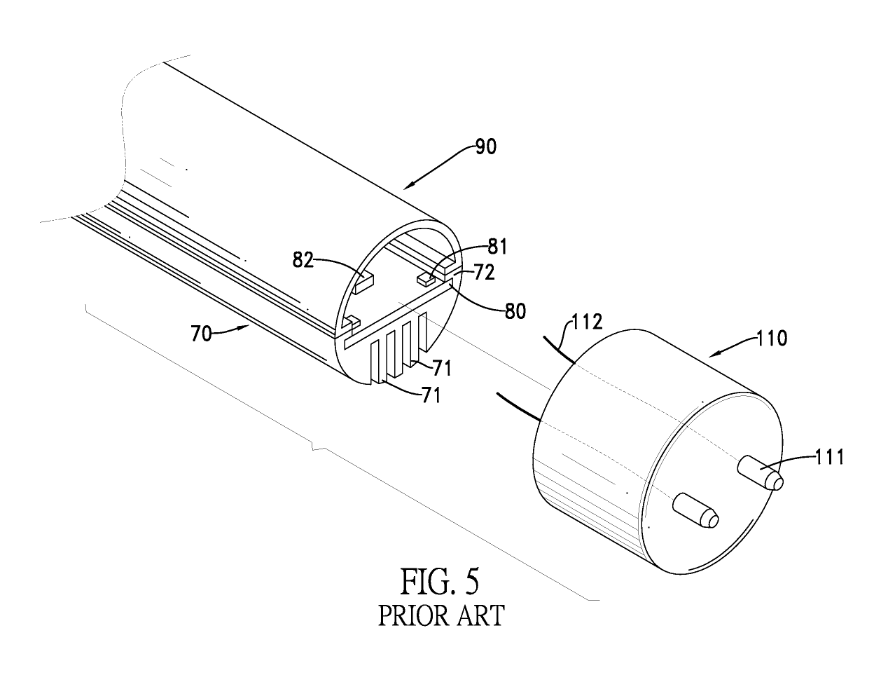

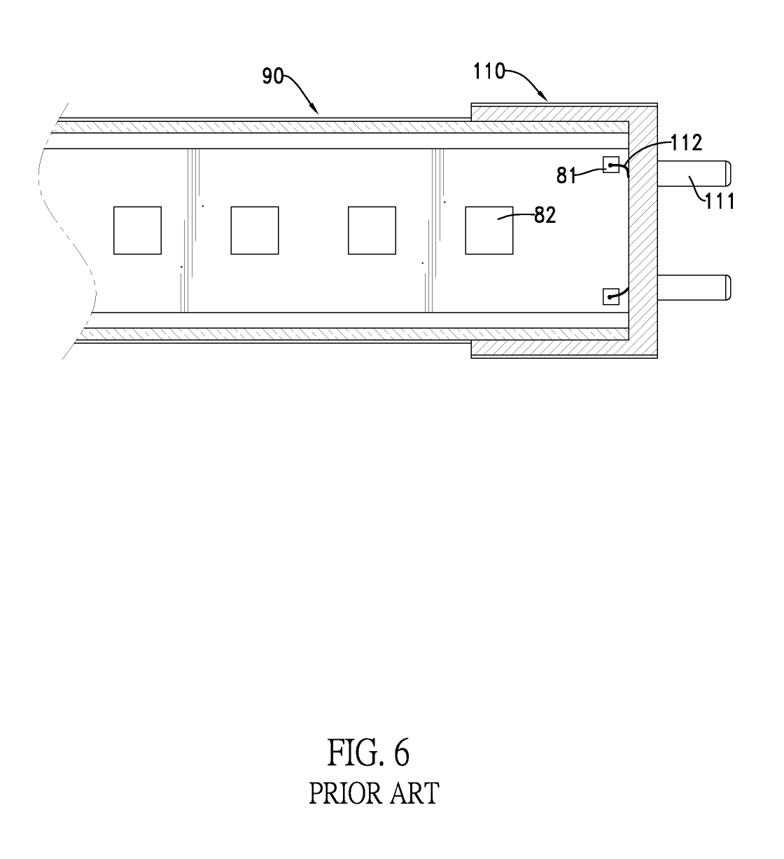

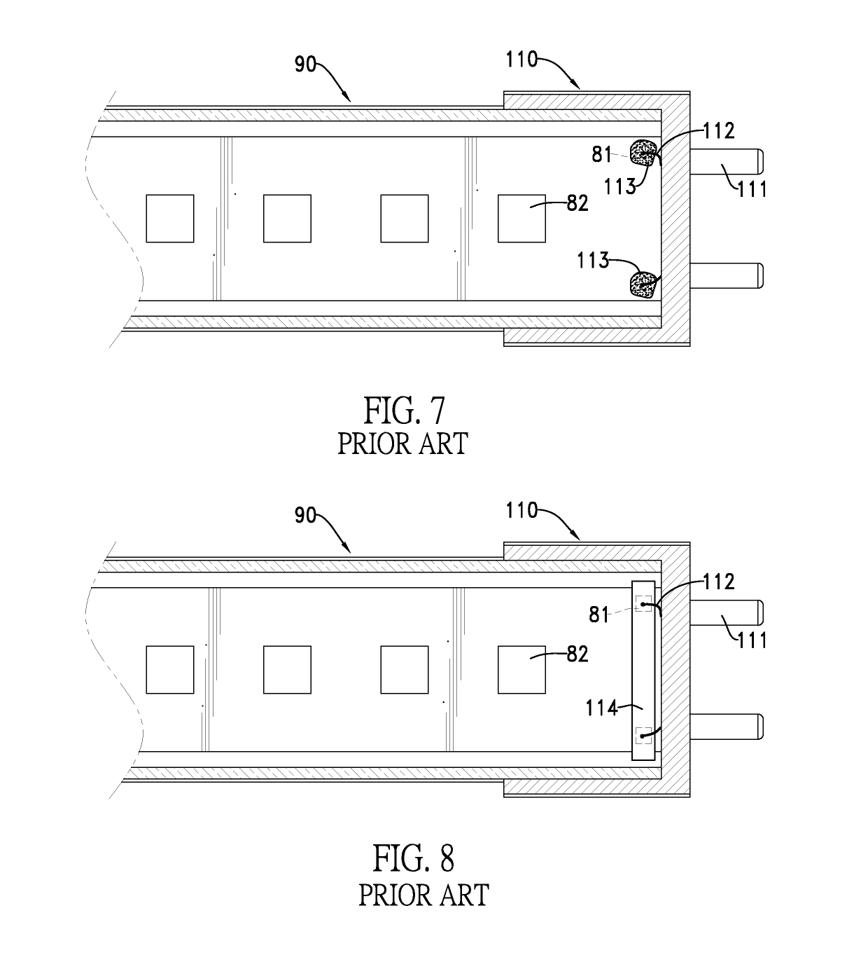

With reference to FIGS. 1, 3 and 4, when the heat-dissipating lamp cap 10 in accordance with the present invention is mounted on the LED tube 40, each end of the LED tube 40 can be inserted into the opening 21 of the heat-dissipating lamp cap 10. The annular wall 22 of the heat-dissipating lamp cap 10 is mounted around the tube cover 50 to fix the heat-dissipating lamp cap 10. The heat-dissipating portion 23 is held within the heat-dissipating notch 52 of the tube cover 50. The abutting portion 332 of the conducting resilient piece 33 is deformed as a result of a pushing force upon mounting and flexibility of the conducting resilient piece 33, and then contacts the power connection portion 612 of the LED light board 60 to electrically connect the electrodes 32 and the LED light board 60 through the conducting resilient piece 33. From the foregoing description, mounting the heat-dissipating lamp cap 10 can be completed without using any soldering process or any electric wire. Accordingly, difficulty in mounting the lamp cap is significantly reduced, and there is no aging or damage issue associated with electric wire, thereby lowering the cost while ensuring the quality in assembly. Prior to the assembly of the heat-dissipating lamp cap 10, the abutting portion 332 can be adjustably aligned to positions associated with power supply in different LED tubes.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A heat-dissipating lamp cap of a light-emitting diode (LED) tube, comprising:
a tubular portion having:
two openings formed through two ends of the tubular portion and opposite to each other; and
an annular wall having a heat-dissipating portion defined as a portion of the annular wall extending axially between the two openings; and
a cap portion covering a corresponding one of the two openings of the tubular portion and having:
an insulating board securely mounted on an inner edge portion of the corresponding opening;
two electrodes mounted through the insulating board; and
a conducting resilient piece mounted on an inner surface of the insulating board and having:
an electrode connection portion formed on the conducting resilient piece and extending radially to electrically connect to the two electrodes; and
an abutting portion formed on and protruding in a direction toward the heat-dissipating portion of the annular wall, and spaced apart from the heat-dissipating portion by a gap.

2. The heat-dissipating lamp cap as claimed in claim 1, wherein the heat-dissipating portion has:
a flat surface formed on an inner side of the heat-dissipating portion; and
multiple fins formed on and protruding outwards from an outer side of the heat-dissipating portion.

3. The heat-dissipating lamp cap as claimed in claim 1, wherein a free end of the abutting portion of the conducting resilient piece is bent toward the opening of the tubular portion that is distal to the free end.

4. The heat-dissipating lamp cap as claimed in claim 2, wherein a free end of the abutting portion of the conducting resilient piece is bent toward the opening of the tubular portion that is distal to the free end.

5. The heat-dissipating lamp cap as claimed in claim 1, wherein the electrode connection portion has two conducting holes formed through the electrode connection portion for the two electrodes of the insulating board to be respectively mounted through the conducting holes.

6. The heat-dissipating lamp cap as claimed in claim 2, wherein the electrode connection portion has two conducting holes formed through the electrode connection portion for the two electrodes of the insulating board to be respectively mounted through the conducting holes.

7. The heat-dissipating lamp cap as claimed in claim 3, wherein the electrode connection portion has two conducting holes formed through the electrode connection portion for the two electrodes of the insulating board to be respectively mounted through the conducting holes.

8. The heat-dissipating lamp cap as claimed in claim 4, wherein the electrode connection portion has two conducting holes formed through the electrode connection portion for the two electrodes of the insulating board to be respectively mounted through the conducting holes.

9. The heat-dissipating lamp cap as claimed in claim 1, wherein two ends of the heat-dissipating portion are respectively flush with the openings of the tubular portion.

10. The heat-dissipating lamp cap as claimed in claim 2, wherein two ends of the heat-dissipating portion are respectively flush with the openings of the tubular portion.

11. The heat-dissipating lamp cap as claimed in claim 3, wherein two ends of the heat-dissipating portion are respectively flush with the openings of the tubular portion.

12. The heat-dissipating lamp cap as claimed in claim 4, wherein two ends of the heat-dissipating portion are respectively flush with the openings of the tubular portion.

13. The heat-dissipating lamp cap as claimed in claim 9, wherein the insulating board has an indentation formed on and recessed inwards from a perimeter of the insulating board to correspond to the heat-dissipating portion for the insulating board to be securely mounted on the inner edge portion of the corresponding opening of the tubular portion.

14. The heat-dissipating lamp cap as claimed in claim 10, wherein the insulating board has an indentation formed on and recessed inwards from a perimeter of the insulating board to correspond to the heat-dissipating portion for the insulating board to be securely mounted on the inner edge portion of the corresponding opening of the tubular portion.

15. The heat-dissipating lamp cap as claimed in claim 1, wherein the insulating board further has an adhesive-filling hole formed on and recessed inwards from a perimeter of the insulating board.

16. The heat-dissipating lamp cap as claimed in claim 13, wherein the insulating board further has an adhesive-filling hole formed on and recessed inwards from a perimeter of the insulating board.

17. The heat-dissipating lamp cap as claimed in claim 14, wherein the insulating board further has an adhesive-filling hole formed on and recessed inwards from a perimeter of the insulating board.

18. The heat-dissipating lamp cap as claimed in claim 1, wherein the tubular portion is made of a metal material.
